(19) United States
(12) Patent Application Publication
(10) Pub. No.: US 2023/0104420 A1
(43) Pub. Date: Apr. 6, 2023

(54) PUCK LOCK SECURITY HASP SYSTEM

(71) Applicant: Ralph Clinton MORTON, Grass Valley, CA (US)

(72) Inventor: Ralph Clinton MORTON, Grass Valley, CA (US)

(21) Appl. No.: 17/960,809

(22) Filed: Oct. 5, 2022

Related U.S. Application Data
(60) Provisional application No. 63/252,754, filed on Oct. 6, 2021.

(51) Int. Cl. E05B 67/06; E05B 65/48

(52) U.S. Cl. CPC E05B 67/063; E05B 65/48

(57) ABSTRACT

The puck lock security hasp system includes a base, curved upright walls extending from the base, flanges extend outwardly from the curved upright walls, and a U-shaped lock. A standard puck lock can be secured on the base within a space between the curved walls. The U-shaped lock can be positioned and secured over the curved walls to block the keyhole of the puck lock. In some embodiments, the U-shaped lock may include: a hollow pipe filled with a dye or paint for marking a thief cutting into the lock; sections of hollow pipe in the straight parts of the shackle for resisting sawing of the shackle; and/or multiple keyholes, with only one being operable to open the lock.

### CROSS-REFERENCE TO RELATED APPLICATION

This application claims the benefit of U.S. Provisional Patent Application No. 63/252,754, filed on Oct. 6, 2021.

### BACKGROUND

### 1. Field

The disclosure of the present patent application relates to puck lock hasps, and particularly to a puck lock security hasp system.

### 2. Description of the Related Art

In general, puck lock systems having puck lock hasps and puck locks are known. These systems provide an extra level of security over standard pad locks, as the shackles of the puck lock hasp and the locking bolt of the puck lock are surrounded (hidden) by the body of the puck lock. An example of a puck lock system is shown in FIG. 8. The system includes a left puck lock hasp half PLH_{L}, a right puck lock hasp half PLH_{R}, and a puck lock PL. The left and right puck lock hasp halves PLH_{L}, PLH_{R}, include mounting holes MH through their planar portions for fasteners to extend through for attaching the halves PLH_{L}, PLH_{R}, to the structures (usually doors) to be locked together. The left puck lock hasp half PLH_{L} includes a first circumferentially extending sidewall CEW extending upwardly and perpendicularly to the planar portion of the left puck lock hasp half PLH_{L}, while the right puck lock hasp half PLH_{R} includes second and third circumferentially extending sidewalls CEW. The sidewalls CEW protect the puck lock PL locking bolt and the hidden hasp tabs or flanges from being jimmied using tools. Such puck locks are easily opened using a puck lock key K_{PL}.

These puck lock systems, while providing greater security than standard padlocks and hasps, still have their limitations. The gaps between the circumferentially extending sidewalls CEW, provide a location for tool entry by a thief attempting to access and defeat the locking bolt and/or hidden shackle. In addition, these systems can always be opened using their corresponding puck lock key K_{PL}. In some situations, it would be desirable to limit the ability of the holder of a valid puck lock key K_{PL} to access the puck lock keyhole PLKH and the protected space. Such puck lock systems do not offer this increased level of security.

Thus, a puck lock security hasp system solving the aforementioned problems is desired.

### SUMMARY

The puck lock security hasp system includes a base including a right half and a left half, curved upright walls extending from each half of the base, flanges extend outwardly from the curved upright walls, and a U-shaped lock. A standard puck lock can be secured on the base within a space between the curved walls, which shroud the puck lock. The U-shaped lock can be positioned and secured over the curved walls to block the keyhole of the puck lock. The U-shaped lock blocks unauthorized access to the sides and keyhole of the puck lock. This may be useful, for example, in storage units, when management needs to lock out a customer behind on their rent. A cover may be provided over the puck lock to protect the lock from ice, snow, rain, and other debris.

The U-shaped lock may be a conventional U-shaped lock, or a modified U-shaped lock. The modified U-shaped lock may include a hollow pipe filled with a dye or paint under pressure. Cutting the U-shaped lock by an intruder can cause the dye to be released onto the intruder. In another embodiment, the U-shaped lock includes cylindrical rods in cylindrical longitudinal cavities of the lock. The rods are configured to spin when contacted by a moving saw. In another embodiment, a crossbar of the U-shaped lock includes multiple keyholes, with only one providing access to open the lock.

These and other features of the present subject matter will become readily apparent upon further review of the following specification and drawings.

### BRIEF DESCRIPTION OF THE DRAWINGS

FIG. 1 is an environmental perspective view of a puck lock security hasp system mounted on the rear doors of a vehicle and housing a puck lock surrounded by a U-shaped lock.

FIG. 2 is an exploded perspective view of the puck lock security hasp system of FIG. 1.

FIG. 3 is an exploded front view of the puck lock security hasp of FIG. 1, shown with the U-shaped lock crossbar removed.

FIG. 4 is a front view of the puck lock security hasp of FIG. 1.

FIG. 5 is a perspective view of a U-shaped lock for use with the puck lock security hasp of FIG. 1.

FIG. 6 is a perspective view of the puck lock security hasp system of FIG. 1, further including a cover.

FIG. 7 is an exploded perspective view of the puck lock security hasp system of FIG. 1, further including a cover.

FIG. 8 is a front, perspective view of a prior art puck lock hasp.

Similar reference characters denote corresponding features consistently throughout the attached drawings.

### DETAILED DESCRIPTION OF THE PREFERRED EMBODIMENTS

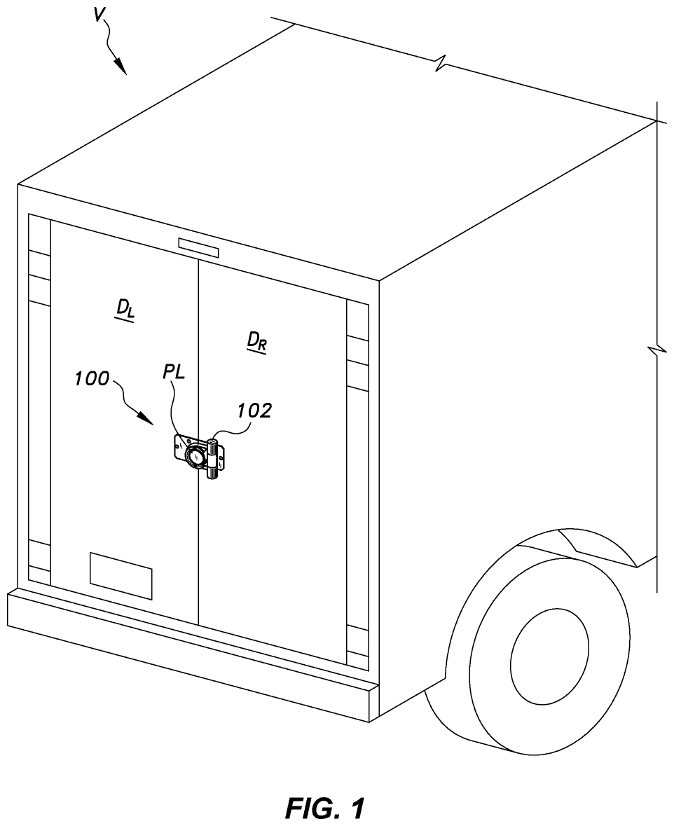

In FIG. 1, the puck lock security hasp system 100 is shown mounted on the back of a vehicle or van V having a left-hand rear door D_{L} and a right-hand rear door D_{R}. The puck lock security hasp system 100 includes a puck lock security hasp. As with conventional puck lock hasps, one half of the puck lock security hasp is mounted on the left-hand rear door D_{L} and the other half of the hasp is mounted on the right-hand rear door D_{R}. A conventional puck lock PL is shown mounted on the puck lock security hasp for locking the two halves of the hasp together. A U-shaped lock 102, also known as a U-lock, is mounted over the puck lock PL and locked, thereby adding a further level of security to the conventional puck lock PL. The U-shaped lock 102 may be a conventional U-shaped lock, or a modified U-shaped lock, as described below with respect to FIG. 5.

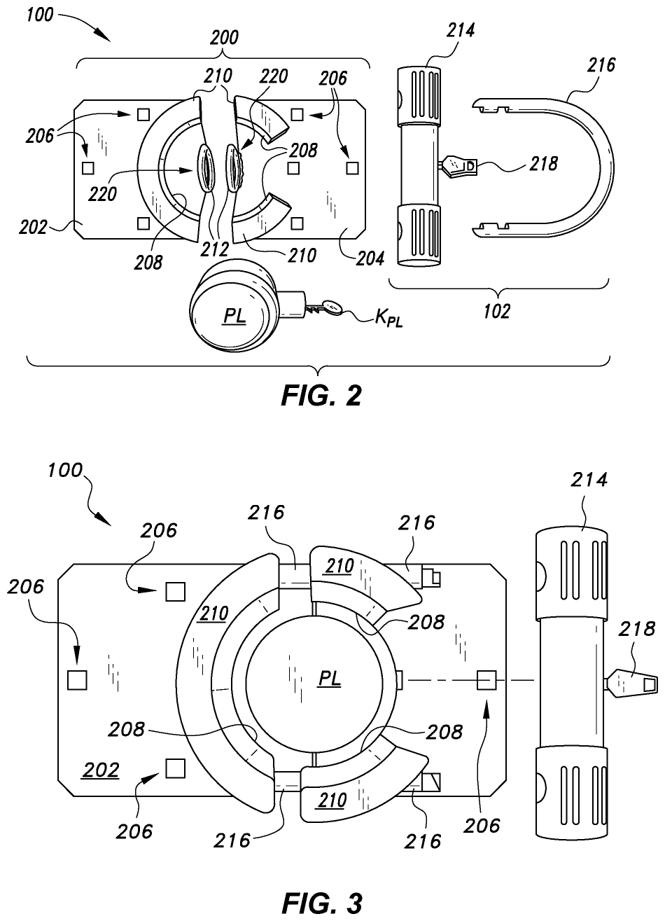

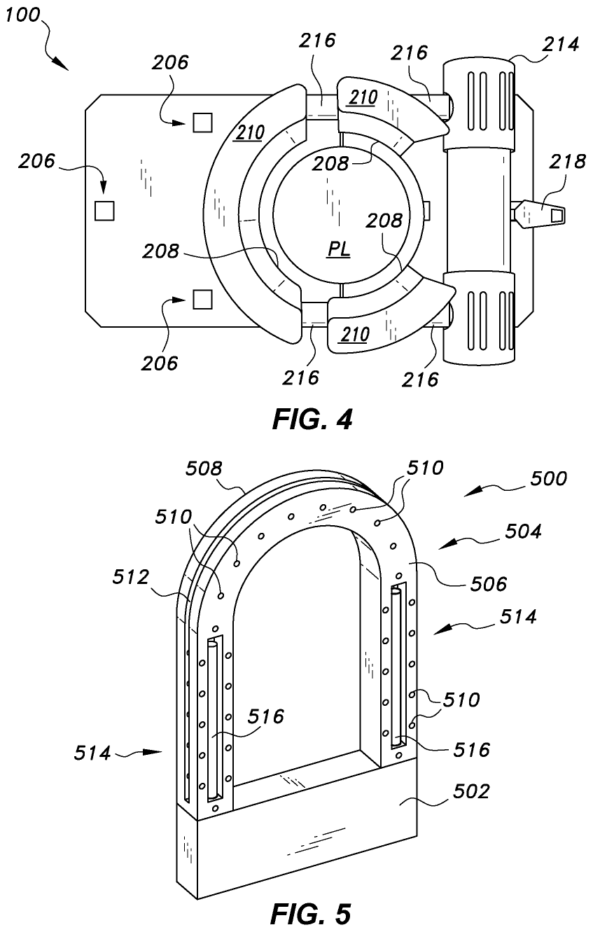

The details of the puck lock security hasp system 100 are shown in FIGS. 2-4. The puck lock security hasp system 100 includes a puck lock security hasp 200, a conventional puck lock PL, and a U-shaped lock 102 or U-lock. The U-shaped lock 102 includes a U-shaped shackle or shank 216 and a crossbar 214. The puck lock security hasp 200 includes a left hasp half 202 and a right hasp half 204, which can be detachably joined together. Each half 202, 204 of the puck lock security hasp 200 includes a planar base with through holes 206 for insertion of fasteners for connecting the halves 202, 204 of the puck lock security hasp 200 to the object to be locked together (e.g. doors), as with conventional puck lock hasps. Also similar to conventional puck lock hasps, each half 202, 204 of the puck lock security hasp 200 includes tabs or hasp flanges 212 extending perpendicularly outward from their respective bases and abutting each other when installed on the door, the tabs or flanges 212 having aligned locking holes 220 through which the locking bolt or shackle of the puck lock PL extends when it is locked on the puck lock security hasp 200. The tabs or hasp shackles 212 are covered and surrounded by the puck lock body, being extended into a slot or channel defined in the rear face of the puck lock body when the puck lock PL is installed on the hasp 200, as shown in FIGS. 3-4. The hasp halves 202, 204, can be joined or abutted at their bases to form a continuous hasp base. A plurality (e.g., three or more) of upright walls 208 are spaced from each other and extend normal to the hasp base. The walls 208 can be curved, forming a generally circular or cylindrical open space or shrouded cylindrical pocket therebetween. A radially extending flange 210 can extend perpendicular to each of the upright walls 208, respectively, and parallel to the hasp base. A channel or groove for snugly receiving the shackle of the U-lock 102 can be formed in the space between each flange 210 and the hasp base.

The puck lock PL can be installed within the space surrounded by the upright walls 208 of the puck lock security hasp 200, in a conventional manner. Exemplary puck locks are shown in U.S. Pat. No. 3,769,821, issued Nov. 6, 1973 to Randel. Such puck lucks PL are flattened cylinders having a smooth and continuous exterior face, a key lock cylinder extending radially inward through the sidewall of the flattened cylinder, and a slot or channel defined in the rear face of the flattened cylinder transverse to the passage for the lock cylinder. A hidden shackle is connected or coupled to the lock cylinder and is moveable with the lock cylinder to extend through the locking holes 220 in the abutting hasp tabs or flanges 212 when the key lock cylinder is locked and retracted when the key lock cylinder is unlocked, the puck lock's shackle continuing in the lock cylinder's passage opposite the slot or channel in the rear face and retained there by a shackle retainer when the key is in the locked position. The U-shaped lock shackle or shank 216 of the U-shaped lock 102 can then be securely positioned about the upright walls 208 within the channel formed between the flanges 210 and the hasp base, as shown in FIG. 3. The U-shaped lock crossbar 214 can then be locked onto the ends of the U-shaped lock shackle 216 by guiding the ends of the U-shaped lock shackle 216 into locking holes of the U-shaped lock crossbar 214, as is commonly done to secure U-shaped locks. The puck lock security hasp system 100 is shown in its fully locked position in FIG. 4. As shown, once secured to the U-shaped lock's shackle 216, the U-shaped lock crossbar 214 can block access to the puck lock keyhole PLKH, and the flanges 210 on the shroud wall 208 prevent an unauthorized person from prying the U-shaped lock 102 off of the hasp 200.

To unlock the puck lock security hasp system 100, a U-shaped lock key 218 can be used to remove the U-shaped lock crossbar 214 from the U-shaped lock shank 216. The U-shaped lock shackle or shank 216 is then removed by pulling the shank 216 away from the hasp 200. The puck lock key KPL, is then used to remove the puck lock PL from the puck lock security hasp 200 in a conventional manner, thereby unlocking the puck lock security hasp system 100. Although a key locking mechanism for the U-shaped lock is described, it should be understood that a combination U-lock may be used instead. A combination lock may be desirable in some circumstances as one would need only to change the combination of the lock to block access to a formerly authorized user (e.g., an employee who is fired).

A modified or security U-shaped lock 500 is shown in FIG. 5. The security U-shaped lock 500 may be used in the puck lock security hasp system 100 or may be used stand-alone in the same manner as any conventional U-shaped lock 500. The external cover layer of the security U-shaped lock 500 has been removed to show the internal details of the lock 500. The lock 500 includes a security U-shaped lock crossbar 502 and a security U-shaped lock shank 504 with ends that lock into holes in the security U-shaped lock crossbar 502 in a manner similar to conventional U-shaped locks. The lock shackle or shank 504 includes a shank front half 506 and a shank back half 508 that are connected to one another by connecting pins 510. An embedded, pressurized security dye 512 is positioned between the shank halves 506, 508 and secured by the external cover layer (not shown). When a thief attempts to saw or cut through the lock shank 504 and cuts through the external cover layer, the pressurized security dye 512 is released, thereby marking the thief for identification by the authorities. The security U-shaped lock shank 504 can further include elongated recesses 514 with cylindrical pins 516 mounted within the recesses 516 that are configured to spin upon impact, e.g., when contacted with a blade. For example, when a thief attempts to saw through the lock shank 504 in these locations and the saw blade reaches the pins 516, the pins 516 spin in a manner that prevents the saw blades from cutting through the pins 516. In an embodiment, the security U-shaped lock cross bar 502 can include multiple keyholes (not shown), with only one keyhole providing access to the cylinder to open the lock.

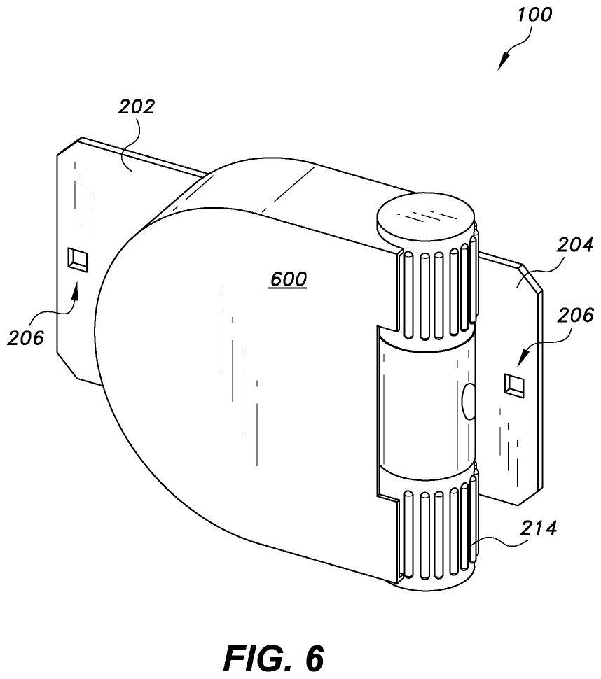

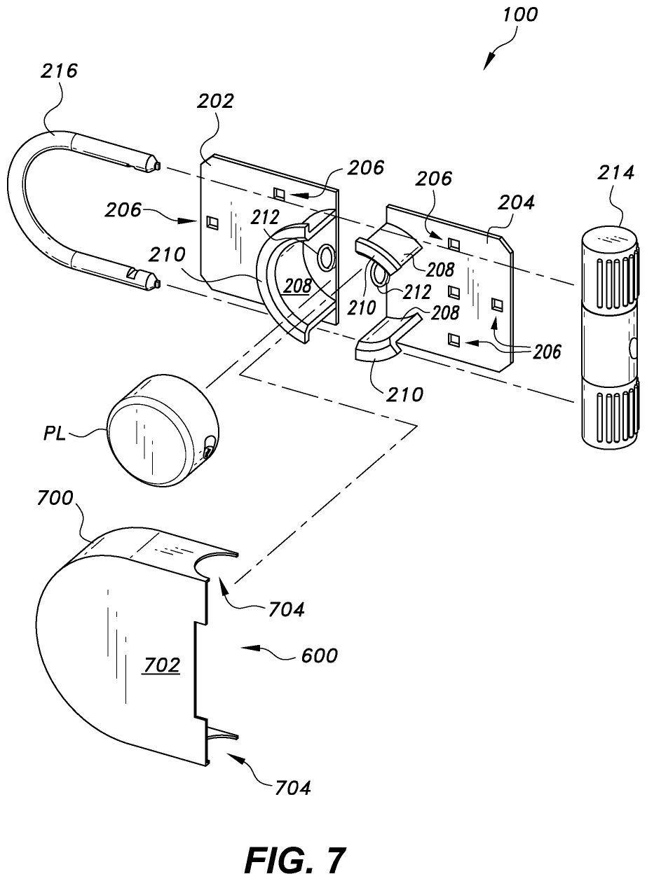

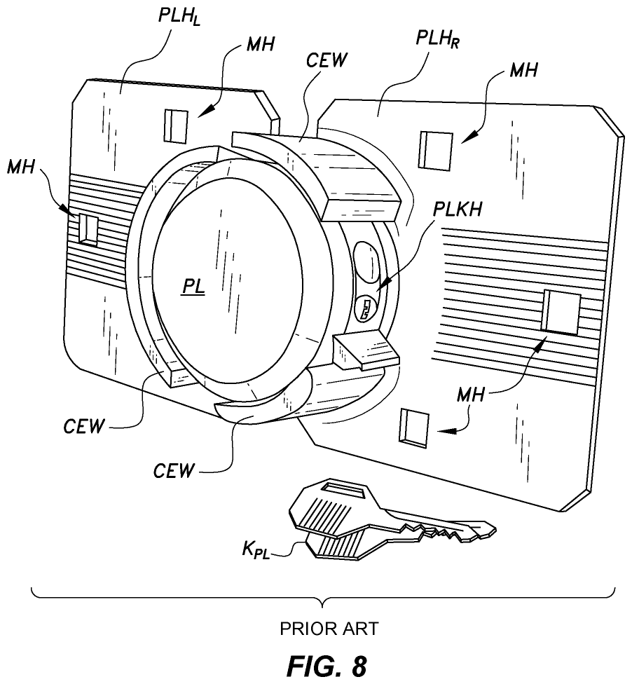

FIGS. 6-7 show the puck lock security hasp system 100 with an optional cover 600. The cover 600 protects the inner portions of the hasp halves 202, 204 and the puck lock PL from ice, snow, rain, and other debris. The cover includes a curved sidewall 700 attached to and integral with a planar top surface 702. The planar top surface 702 includes a semi-circular edge and three substantially straight edges. The curved sidewall 700 extends perpendicularly from the semi-circular edge and the two adjacent straight edges. The two ends of the curved sidewall 700 include semicircular recesses 704. The cover 600 is installed prior to installing the U-shaped lock crossbar 214, as shown in FIG. 3. After installing the cover 600, the U-shaped lock crossbar 214 is installed with the cylindrical ends of the U-shaped lock crossbar 214 abutting the ends of the curved sidewall 700 within the semicircular recesses 704, to thereby form a closed structure. The cover 600 can be formed from a durable metal, such as heavy-gauge steel. Use of the cover 600 can provide an additional level of security by, e.g., hiding from view the underlying puck lock PL and U-lock structures.

It is to be understood that the puck lock security hasp system is not limited to the specific embodiments described above but encompasses any and all embodiments within the scope of the generic language of the following claims enabled by the embodiments described herein, or otherwise shown in the drawings or described above in terms sufficient to enable one of ordinary skill in the art to make and use the claimed subject matter.

We claim:

1. A puck lock security hasp system, comprising:
a left puck lock security hasp half, including
a first planar base;
a first tab extending outward from the first planar base and having a first locking hole defined therein;
a first upright wall extending orthogonally from the first planar base; and
a first radially extending flange extending outward normal to the first upright wall and parallel to the first planar base, forming a channel between the base and the first radially extending flange; and
a right puck lock security hasp half, including:
a second planar base;
a second tab extending outward from the second planar base and having a second locking hole defined therein, the first and second tabs abutting and the first and second locking holes being aligned with each other when the first and second planar bases are installed;
a second upright wall extending orthogonally from the second planar base;
a second radially extending flange extending outward normal to the second upright wall and parallel to the base, forming a channel between the base and the second radially extending flange;
a third upright wall extending orthogonally from the second planar base; and
a third radially extending flange extending outward normal to the third upright wall and parallel to the second planar base, forming a channel between the base and the third radially extending flange, the first, second, and third upright walls defining a segmented circular shroud adapted for receiving a puck lock when the hasp is installed with the tabs abutting hinder lateral access for tampering with the puck lock.

2. The puck lock security hasp system of claim 1, further comprising a flat cylindrical puck lock disposed within the segmented circular shroud defined by the upright walls of the puck lock security hasp when the hasp halves are installed with the hasp halves and the tabs abutting to form a continuous hasp base, the puck lock having a locking bolt shackle extending through the locking holes of the hasp when the puck lock is in a locked position.

3. A puck lock security hasp system according to claim 2, further comprising a U-shaped lock having:
a U-shaped lock shackle having opposing parallel ends; and
a lock cross-bar detachably connected to ends of the U-shaped lock shackle, the U-shaped lock shackle being configured to snugly fit in the channel defined by the upright walls the flanges extending outward normal to the upright walls.

4. The puck lock security hasp system of claim 3, wherein the shackle of said U-shaped lock has a shackle front half, a shackle back half, a pressurized dye disposed between the shackle front half and the shackle back half, and a first plurality of pins configured for connecting the shackle front half and the shackle back half.

5. The puck lock security hasp system of claim 4, wherein the lock shackle of said U-shaped lock has at least one elongated recess defined therein and a second plurality of pins extending within the at least one elongated recess, the second plurality of pins being configured to spin upon impact.

6. The puck lock security hasp system of claim 1, further comprising a cover including:
a curved sidewall having two recessed ends; and
a planar top surface including a semi-circular edge and three substantially straight edges, the curved sidewall extending perpendicularly from the semi-circular edge and the two adjacent straight edges.

7. A puck lock security hasp system, comprising:
a hasp having symmetrical left and right hasp halves, each of the hasp halves including:
a planar base having a peripheral edge;
a tab extending orthogonally from the peripheral edge of the planar base;
at least one arcuate upright wall extending orthogonally from the planar base, the at least one arcuate walls defining a cylindrical lock pocket when the right and left hasp halves are installed on two members of a workpiece with the tabs and portions of the peripheral edges abutting each other, the abutting tabs being disposed within the cylindrical lock pocket and having a shackle hole defined therein; and
flanges extending radially outward from an upper edge of the at least one arcuate upright wall parallel to the planar base to define a channel extending around the cylindrical lock pocket; and
a puck lock removably disposed within the cylindrical lock pocket, the puck lock having a shackle selectively extending through the shackle hole defined in the abutting hasp halves when the puck lock is in a locked position to lock the two members of the workpiece together.

8. A puck lock security hasp system according to claim 7, further comprising a U-lock having a U-shaped shackle having opposing ends and a locking cross-bar detachably connected to the ends of the U-shaped shackle, the U-shaped lock being configured to extend about the channel extending around the cylindrical lock pocket of said hasp.

9. The puck lock security hasp system of claim 8, wherein the U-shaped shackle of said U-lock has a shackle front half, a shackle back half, a pressurized dye disposed between the shackle front half and the shackle back half, and a first plurality of pins configured for connecting the shackle front half and the shackle back half.

10. The puck lock security hasp system of claim 9, wherein the U-shaped shackle of said U-lock has at least one elongated recess defined therein and further comprises a second plurality of pins extending within the at least one elongated recess, the second plurality of pins configured to spin upon impact.

11. A U-lock, including:
a U-shaped lock shank comprising a shank front half, a shank back half, a dye disposed between the shank front half and the shank back half, and a first plurality of pins configured for onnecting the shank front half and the shank back half; and
a lock cross-bar detachably connected to ends of the U-shaped lock shank.

12. The U-lock of claim 11, wherein the lock shank further includes at least one elongated recess defined therein and a second plurality of pins extending within the at least one elongated recess, the second plurality of pins being configured to spin upon impact.
